(19) United States
(12) Patent Application Publication
(10) Pub. No.: US 2014/0349693 A1
(43) Pub. Date: Nov. 27, 2014

(54) METHOD OF PROVIDING MILLIMETER WAVE BAND-BASED COMMUNICATION CONNECTION SERVICE

(71) Applicant: Electronics and Telecommunications Research Institute, Daejeon (KR)

(72) Inventors: Jong Ho KIM, Daejeon (KR); Myoung-Won JUNG, Daejeon (KR); Young Keun YOON, Daejeon (KR); Joo Hwan LEE, Daejeon (KR); Young Jun CHONG, Daejeon (KR)

(21) Appl. No.: 13/937,831

(22) Filed: Jul. 9, 2013

(30) Foreign Application Priority Data
May 21, 2013 (KR) 10-2013-0057093

(51) Int. Cl. H04W 48/20

(52) U.S. Cl. CPC H04W 48/20
USPC 455/500

(57) ABSTRACT

A method of providing millimeter wave band-based communication connection service, includes measuring a strength of a signal received from at least one base station that forms at least one cell; and storing signal data based on the measured strength of the signal so that the signal data is mapped to the at least one base station. Further, the method includes selecting any one base station from among the at least one base station based on the stored signal data; and connecting communication to the selected base station. Further, the method is performed on a millimeter wave band-based mobile communication terminal.

### CROSS-REFERENCE TO RELATED APPLICATION(S)

The present invention claims priority of Korean Patent Application No. 10-2013-0057093, filed on May 21, 2013, which is incorporated herein by reference.

### FIELD OF THE INVENTION

The present invention relates to a method of providing millimeter wave band-based communication connection service; and, more particularly, to a method of continuously maintaining a communication connection between a mobile communication terminal and a base station in the millimeter wave band.

### BACKGROUND OF THE INVENTION

Recently, with the popularization of mobile communication service, available frequency bands have become increasingly scarce, and so the millimeter wave band that had previously been used mainly for military purposes has attracted attention as a viable radio wave band for next generation wireless communication, and a great deal of research has been carried out into the millimeter wave band.

In this case, a method of providing communication service using millimeter waves is performed by using a method of providing wireless communication using a plurality of relays. In connection with a method of providing a wireless network system, in the prior art, there is disclosed a method of providing wireless communication service to a terminal over a specific distance via ultra-wide band (UWB) repeaters that are located in buildings or spaces inside buildings.

However, the conventional method does not disclose a configuration for applying millimeter waves to a mobile communication network when providing millimeter wave-based communication service. Furthermore, when millimeter waves are applied to a mobile communication network, a problem arises in that, if an obstacle is located between a base station and a terminal, attenuation is increased due to reflection or diffraction, which may result in a communication connection being unintentionally dropped.

### SUMMARY OF THE INVENTION

In view of the above, the present invention provides a method of providing millimeter wave band-based communication connection service that is capable of preventing a connection between a communication base station and a mobile communication terminal from being unintentionally released even when the millimeter wave band is applied to a mobile communication network. However, the present invention is not limited thereto, and there may be other objects.

In accordance with a first aspect of the present invention, there is provided a method of providing millimeter wave band-based communication connection service, the method being performed on a millimeter wave band-based mobile communication terminal. The method includes measuring a strength of a signal received from at least one base station that forms at least one cell; storing signal data based on the measured strength of the signal so that the signal data is mapped to the at least one base station; selecting one base station from among the at least one base station based on the stored signal data; and connecting communication to the selected base station.

In accordance with a second aspect of the present invention, there is provided a millimeter wave band-based communication connection terminal. The millimeter wave band-based communication connection terminal includes a measurement unit configured to measure a strength of a signal received from at least one base station that forms at least one cell; a storage unit configured to store signal data based on the measured strength of the signal so that the signal data is mapped to the at least one base station; a selection unit configured to, if a strength of a signal between the mobile communication terminal and a base station to which the mobile communication terminal has been connected is equal to or lower than a preset signal strength, select one base station from among the at least one base station based on the stored signal data; and a connection unit configured to connect communication to the selected base station.

In accordance with an aspect of the present invention, one or more base stations transmit signal separately from communication signals, and a mobile communication terminal receives the separate signals and arranges the separate signals according to the strength thereof, and, if communication is disconnected, generates a connection based on data about the arranged signals, thereby maintaining communication quality at a constant level.

### BRIEF DESCRIPTION OF THE DRAWINGS

The above and other objects and features of the present invention will become apparent from the following description of embodiments given in conjunction with the accompanying drawings, in which:

FIG. 1 is a diagram illustrating the configuration of a system for providing millimeter wave band-based communication connection service in accordance with an embodiment of the present invention;

FIG. 2 is a diagram illustrating the configuration of the mobile communication terminal illustrated in FIG. 1;

FIGS. 3A and 3B are diagrams illustrating the comparison between an embodiment in which the mobile communication terminal illustrated in FIG. 1 is connected to the base station and a conventional technology;

FIG. 4 is a diagram illustrating a process in which the mobile communication terminal illustrated in FIG. 1 is connected to a base station; and

FIG. 5 is a flowchart illustrating a method of providing millimeter wave band-based communication connection service in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Throughout the specification and the claims, when an element is described as being “connected” to another element, this implies that the elements may be directly connected together or the elements may be connected through one or more intervening elements. Furthermore, when an element is described as “including” one or more elements, this does not exclude additional, unspecified elements, nor does it preclude the presence or addition of one or more other features, integers, steps, operations, elements, components and/or groups thereof.

The present invention will be described in detail below with reference to the accompanying drawings.

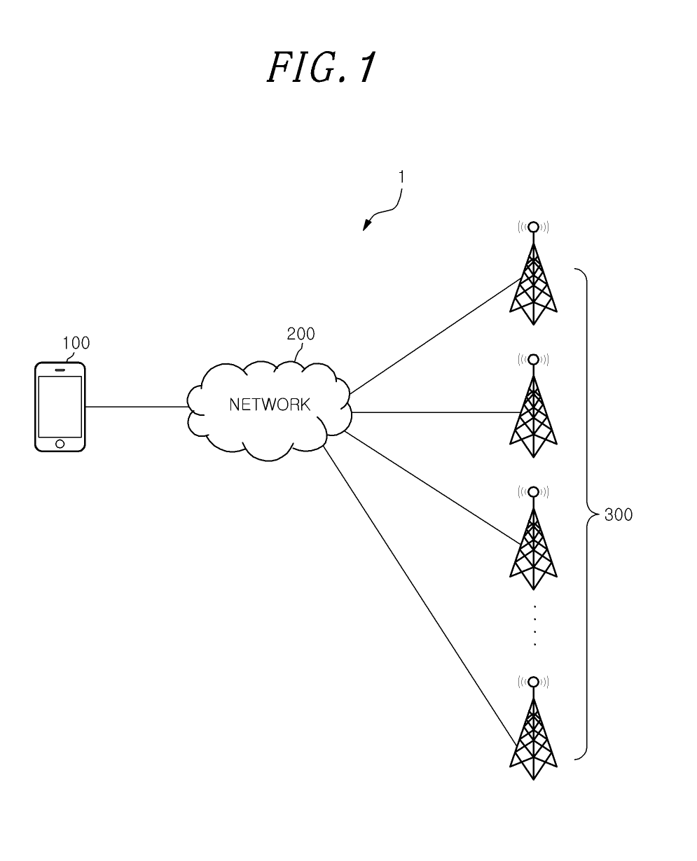

FIG. 1 is a diagram illustrating the configuration of a system 1 for providing millimeter wave band-based communication connection service in accordance with an embodiment of the present invention. Referring to FIG. 1, the system 1 for providing millimeter wave band-based communication connection service may include a mobile communication terminal 100 and at least one base station 300. However, the system 1 for providing millimeter wave band-based communication connection service shown in FIG. 1 is merely an embodiment of the present invention, and thus the present invention is not interpreted as being limited to the configuration of FIG. 1.

In this case, the components of FIG. 1 are generally connected to each other over a network 200. For example, as illustrated in FIG. 1, the mobile communication terminal 100 and the at least one base station 300 may be connected to each other over the network 200. In this case, the network 200 refers to a connection structure that enables information to be exchanged between nodes, such as terminals and servers. Examples of the network 200 may include the Internet, a Local Area Network (LAN), a Wireless Local Area Network (Wireless LAN), a Wide Area Network (WAN), a Personal Area Network (PAN), and 3G, 4G, LTE, Wi-Fi, and ZigBee networks, but are not limited thereto. Furthermore, the mobile communication terminal 100 and the at least one base station 300 disclosed in FIG. 1 are not construed as being limited to those illustrated in FIG. 1.

The mobile communication terminal 100 refers to a wireless communication device in which portability and mobility are guaranteed. Examples of the mobile communication terminal 100 may include all types of handheld-based wireless communication devices, such as a Personal Communication System (PCS) terminal, a Global System for Mobile communications (GSM) terminal, a Personal Digital Cellular (PDC) terminal, a Personal Handyphone System (PHS) terminal, a Personal Digital Assistant (PDA), an International Mobile Telecommunication (IMT)-2000 terminal, a Code Division Multiple Access (CDMA)-2000 terminal, a W-Code Division Multiple Access (W-CDMA) terminal, a Wireless Broadband Internet (Wibro) terminal, a smart phone, a smart pad, and a tablet PC.

The at least one base station 300 may be one of the components that constitute a mobile communication system. The at least one base station 300 functions to relay signals between a mobile station and a switching center in a cell, and may be present in each cell. Furthermore, the at least one base station 300 may include at least one of incoming and outgoing signal transmission, call channel monitoring, and self-diagnosis functions as well as the function of performing interfacing between a mobile station and a switching center, and may control a cell area under its charge.

A method of providing millimeter wave band-based communication connection service in accordance with an embodiment of the present invention will be described below by way of example.

Since a mobile communication network using the millimeter wave band suffers from high loss due to frequency characteristics, only a propagation path of direct waves among direct waves, reflected waves, and diffracted waves can be formed. Accordingly, if an obstacle is located on a propagation path when the millimeter wave band is used for a mobile communication network, this may be a cause of the generation of a non-line-of-sight (NLOS) path.

Furthermore, in an existing cellular mobile communication network, a single base station and a plurality of terminals are present in a single cell, and the plurality of terminals communicates with the base station within the cell. In this case, when any one of the plurality of terminals moves to another cell, it temporarily detects two base stations, but immediately communicates with a base station within the other cell when it enters into the other cell. Accordingly, when the existing cellular mobile communication method is applied to the millimeter wave band, only a single base station is detected within a single cell, and thus a phenomenon in which a communication signal is dropped may occur.

As a result, the system for providing millimeter wave band-based communication connection service in accordance with this embodiment of the present invention is configured such that a single mobile communication terminal continuously detects a plurality of base stations and is allowed to be connected to one of the base stations based on the detected strengths of signals when a situation of an NLOS path occurs, thereby preventing a communication signal from being disconnected.

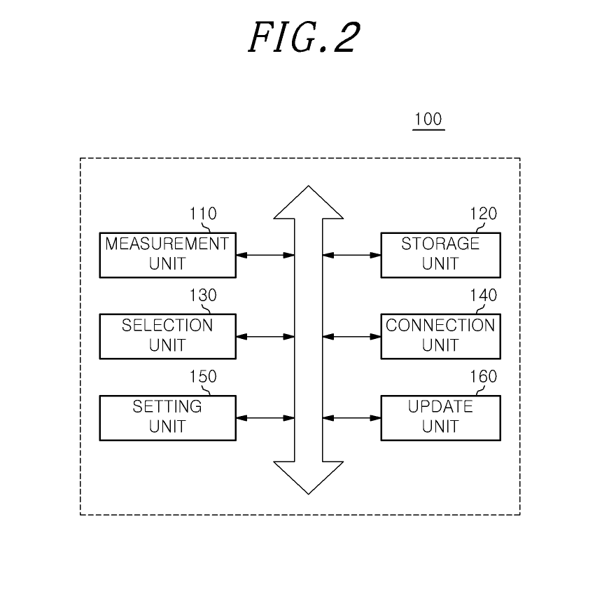

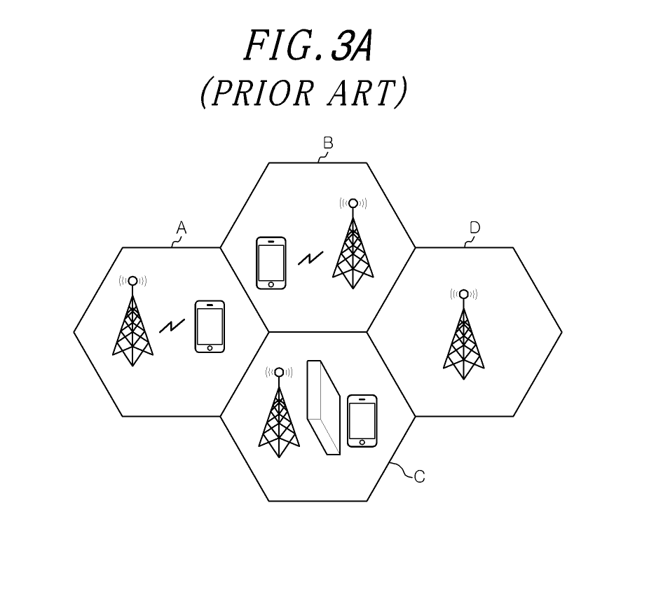

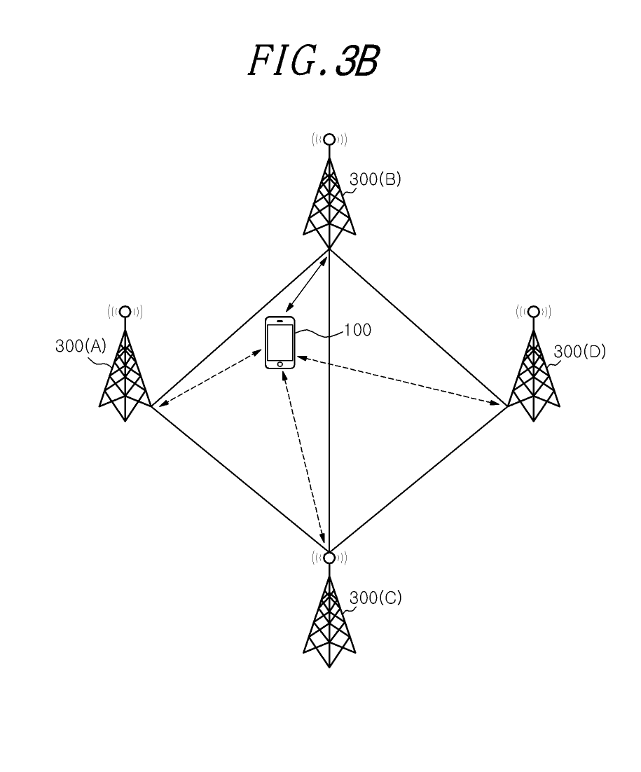

FIG. 2 is a diagram illustrating the configuration of the mobile communication terminal illustrated in FIG. 1, and FIGS. 3A and 3B are diagrams illustrating the comparison between an embodiment in which the mobile communication terminal illustrated in FIG. 1 is connected to the base station and a conventional technology.

Referring to FIG. 2, the mobile communication terminal 100 in accordance with this embodiment of the present invention includes a measurement unit 110, a storage unit 120, a selection unit 130, and a connection unit 140. In this case, the mobile communication terminal 100 may further include a setting unit 150 and an update unit 160.

The measurement unit 110 measures the strength of a signal received from at least one base station 300 that forms at least one cell. In this case, the measurement unit 110 may adjust a measurement cycle while considering the remaining power of the battery of the mobile communication terminal 100. For example, if it is assumed that a measurement cycle is set to 10 minutes by default, the measurement cycle may be adjusted to a period longer than 10 minutes when the ratio of the remaining power of the battery is lower than 20%. Alternatively, the measurement unit 110 may consider a measurement cycle input by a user first. For example, it is assumed that a measurement cycle is set to 10 minutes by default. In this case, if a measurement cycle input by a user is one minute, the measurement unit 110 may disregard the default value and perform measurement based on the measurement cycle input by the user.

In this case, the at least one base station 300 may transmit a signal for communication connection service to the mobile communication terminal 100. In this case, the signal may be a signal that is transmitted to the mobile communication terminal separately from a communication signal. For example, if it is assumed that a signal transmitted from the least one base station 300 to perform the communication connection of the mobile communication terminal 100 is A, the at least one base station 300 may transmit signal B for communication connection service to the mobile communication terminal 100 separately from the signal A.

The storage unit 120 stores signal data based on the measured strength of each signal so that it is mapped to the at least one base station 300. In this case, the storage unit 120 may arrange signal data based on measured signals in descending or ascending order, classify the signal data according to the strength, and then store the signal data. For example, it is assumed that the mobile communication terminal 100 detects base station A, B, C, and D and the strengths of signals received from the detected base stations are 10, 50, 35, and 19, respectively. In this case, the storage unit 120 may map B, C, D, and A to 50, 35, 19, and 10, respectively, and arrange the signal data in descending order, or may map A, D, C, and B to 10, 19, 35, and 50, respectively, and arrange the signal data in ascending order.

The selection unit 130 selects any one base station from the at least one base station 300 based on the stored signal data. In this case, when the above-described example is used again, the selection unit 130 may select B mapped to in a first line when the signal data is arranged in descending order, or may select B mapped to 50 in a last line when the signal data is arranged in ascending order. Furthermore, if the signal strength between the mobile communication terminal 100 and a base station to which the mobile communication terminal 100 is connected is equal to or lower than a preset signal strength, the selection unit 130 may select any one base station based on stored signal data. In this case, the above-described example is used again. For example, it is assumed that the preset signal strength is 30 and the strength of a signal received from the base station B is 29. In this case, if the strength of a signal received from base station B, that is, 29, is lower than the preset signal strength, that is, 30, the selection unit 130 may select the base station C. Furthermore, if there is a base station connected to the mobile communication terminal 100, the selection unit 130 selects any one base station based on the stored signal data.

The connection unit 140 connects communication to the selected base station.

The setting unit 150 may set the at least one base station 300 except for the selected base station to a standby state. In this case, when the above-described example is used again, the base stations A, C, and D other than the base station B may be set to a communication standby state.

The update unit 160 may measure the strengths of signals, which are received from a plurality of base stations that form a plurality of cells, in real time or periodically based on the location of the mobile communication terminal 100. Furthermore, the update unit 160 may compare signal data measured in real time or periodically with the previously stored signal data, and, if the measured signal data is not identical to the previously stored signal data, update the stored signal data with the measured signal data. For example, it is assumed that the signal data previously stored in the storage unit 120 is A mapped to 10, B mapped to 50, C mapped to 35, and D mapped to 19 and the signal data measured by the update unit 160 is B mapped to 89, C mapped to 78, D mapped to 20, and E mapped to 33. In this case, since the stored signal data is not identical to the measured signal data, the update unit 160 may update the previously stored signal data, that is, A mapped to 10, B mapped to 50, C mapped to 35, and D mapped to 19, with the measured signal data, that is, B mapped to 89, C mapped to 78, D mapped to 20, and E mapped to 33. In this case, the updating may be performed using an overwrite method.

Furthermore, if the difference between the two types of signal data falls within a preset ratio when the signal data measured in real time or periodically with the stored signal data, the update unit 160 may not perform updating. For example, settings may be made such that the update unit 160 does not perform updating if the difference between the two types of signal data is within the range of ±1%.

Furthermore, the update unit 160 measures the strengths of signals received from a plurality of base stations that form a plurality of cells, and may perform measuring in real time or periodically, depending on the location of the mobile communication terminal 100. In this case, the update unit 160 may compare signal data measured in real time or periodically with previously stored signal data, and, if the measured signal data is identical to the previously stored signal data, maintains the previously stored signal data. Accordingly, the connection unit 140 may maintain communication connection with the selected base station.

Furthermore, the selection unit 130 may compare the strength of a signal that is the strongest of the updated signals with the strength of a signal received from a base station to which the mobile communication terminal 100 has been connected. In this case, if the strength of the strongest signal is higher than a signal received from a base station to which the mobile communication terminal 100 is connected, the connection unit 140 may connect communication to a base station that transmits the strongest signal. For example, it is assumed that the update unit 160 updates the signal data to A mapped to 50, B mapped to 24, C mapped to 45, and D mapped to 35 and a signal received from a base station to which the mobile communication terminal 100 has been currently connected corresponds to E mapped to 45. In this case, the selection unit 130 compares E mapped to 45 with A mapped to 50, B mapped to 24, C mapped to 45, and D mapped to 35. Since, as a result of the comparison by the selection unit 130, 50 to which A is mapped is higher than 45 to which E is mapped, the connection unit 140 may release a connection to E and set up a connection to A.

Furthermore, the selection unit 130 compares the strength of a signal that is the strongest of updated signals with the strength of a signal received from a base station mobile to which the communication terminal 100 has been connected. In this case, if the strength of the strongest signal is equal to or lower than the strength of the signal received from the base station mobile to which the communication terminal 100 has been connected, the connection unit 140 may maintain a connection to the base station mobile to which the communication terminal 100 has been connected. For example, it is assumed that the update unit 160 updates the signal data to A mapped to 50, B mapped to 24, C mapped to 45, and D mapped to 35 and a signal received from a base station to which the mobile communication terminal 100 has been currently connected corresponds to E mapped to 80. In this case, the selection unit 130 compares E mapped to 80 with A mapped to 50, B mapped to 24, C mapped to 45, and D mapped to 35. Since, as a result of the comparison by the selection unit 130, 80 to which E is mapped is higher than 50 to which A is mapped, the connection unit 140 may maintain a connection to E.

An embodiment configured and operated as described above will be compared with the conventional technology below.

Referring to FIGS. 3A and 3B, FIG. 3A illustrates a conventional method of detecting base stations, and FIG. 3B illustrates the method of detecting base stations in accordance with this embodiment of the present invention base station. Referring to FIG. 3A, when a terminal that is communicating with the base station of cell A moves to the base station area of cell B, the terminal instantaneously connects to both the base station of the cell A and the base station of the cell B at the boundary between the cell A and the cell B. Thereafter, the terminal is connected to and communicates with only the base station of the cell B. That is, every terminal is connected to a single base station always except for the time at which the terminal is located at the boundary between cells. Furthermore, although an obstacle is located between a terminal and a base station, as illustrated in cell C, a propagation path may be maintained using reflected waves or diffracted waves in a mobile communication network using the VHF or UHF band. In contrast, if an obstacle is located when the conventional method of detecting base stations is applied to the millimeter wave band, a propagation path cannot be maintained because of attenuation attributable to reflection or diffraction.

Referring to FIG. 3B, the method of detecting base stations in accordance with this embodiment of the present invention base station newly defines the concept of cell areas and adds functionality to the mobile communication terminal 100, thereby enabling mobile communication to be performed via the millimeter wave band even when there is an obstacle between the mobile communication terminal 100 and the base station 300 A, 300 B, 300 C, or 300 D. That is, in the conventional method of detecting base stations, a cell area is an area that extends to the boundary of a cell that a single base station has, and, in accordance with an embodiment of the present invention, a cell area is an area that is surrounded by base station 300 A, 300 B, 300 C, and 300 D around the mobile communication terminal 100. In this case, the mobile communication terminal 100 is present in a cell coverage, and the mobile communication terminal 100 may always check the levels of signals received from the adjacent base stations 300 A, 300 B, 300 C, and 300 D. In this case, it is assumed that the levels of signals received from the base stations 300 A, 300 B, 300 C, and 300 D have the relationships of A>B=C>D.

In this case, the mobile communication terminal 100 is connected to the base station 300 B from which the strongest signal is received, and the base stations 300 B, 300 C, and 300 D are set to a standby state. If a connection to the base station 300 B is released because of the presence of an obstacle between the mobile communication terminal 100 and the base station 300 B or for another reason while the mobile communication terminal 100 is moving, the mobile communication terminal 100 is allowed to be connected to the base station 300 D from which the next strongest signal is received.

For this purpose, the base stations 300 A, 300 B, 300 C, and 300 D may transmit unique constant signals separately from communication signals. Furthermore, the mobile communication terminal 100 may check signals that are transmitted by the base stations 300 A, 300 B, 300 C and 300 D, and may arrange and store the checked signals in order of strength, or continuously update information as the situation changes.

Since some descriptions of the method of providing millimeter wave band-based communication connection service, which is illustrated in FIGS. 2 to 3B, are the same as or can be easily derived from those of the millimeter wave band-based communication connection method given in conjunction with FIG. 1, they will be omitted.

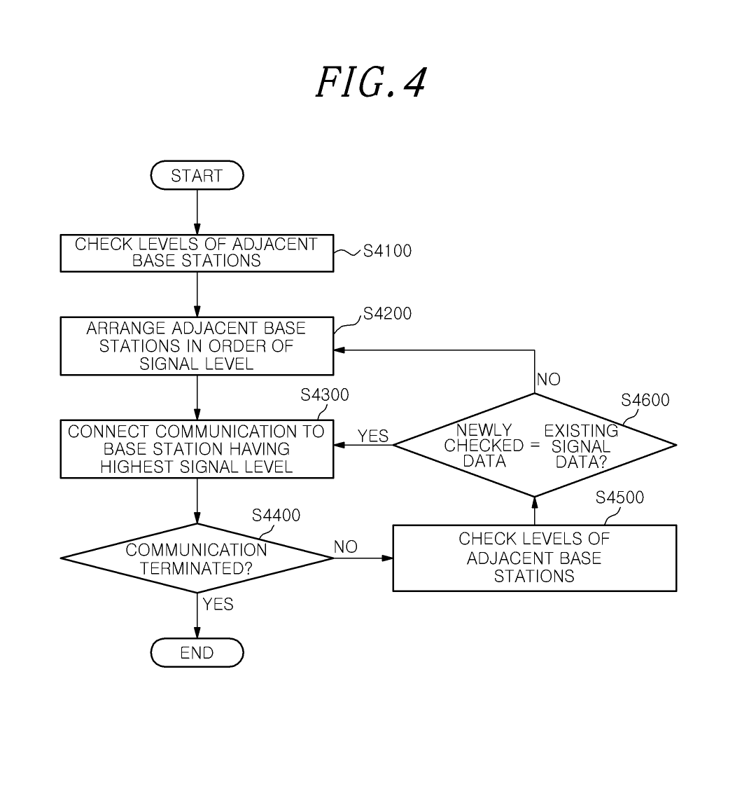

FIG. 4 is a diagram illustrating a process in which the mobile communication terminal illustrated in FIG. 1 is connected to a base station. Although an example of the process in which signals are transmitted and received in accordance with an embodiment of the present invention will be described in conjunction with FIG. 4, it will be apparent to those skilled in the art that the present invention is not limited to this embodiment, and the process in which signals are transmitted and received, which is illustrated in FIG. 4, may be modified based on the foregoing various embodiments.

Referring to FIG. 4, the mobile communication terminal 100 checks the signal levels of the adjacent base stations 300 at step S4100, and arranges the adjacent base station 300 in order of their received signal level at step S4200.

Thereafter, the mobile communication terminal 100 connects communication to a base station having the highest signal level at step S4300, and continuously checks the signal levels of the adjacent base stations 300 at step S4500 until communication is terminated at step S4400. Furthermore, the mobile communication terminal 100 continuously checks the signals of the adjacent base stations 300, compares the newly checked data with existing data at step S4600, and, if a change occurs, sets the newly checked data as new data and deletes the existing data. Furthermore, the mobile communication terminal 100 attempts to connect to a base station that transmits a signal that is the strongest of the new data. The mobile communication terminal 100 compares the newly checked data with existing data, and, if there is no change, maintains the existing data and also maintains a current connection to a base station. Finally, this algorithm is repeatedly performed until the communication is terminated at step S4400.

Since some descriptions of the method of providing millimeter wave band-based communication connection service, which is illustrated in FIG. 4, are the same as or can be easily derived from those of the millimeter wave band-based communication connection method given in conjunction with FIGS. 1 to 3, they will be omitted.

The sequence of the above-described steps S4100-S4600 is merely an example, and they are not limited thereto. That is, the sequence of the above-described steps S4100-S4600 may vary, or some steps thereby may be performed concurrently or deleted.

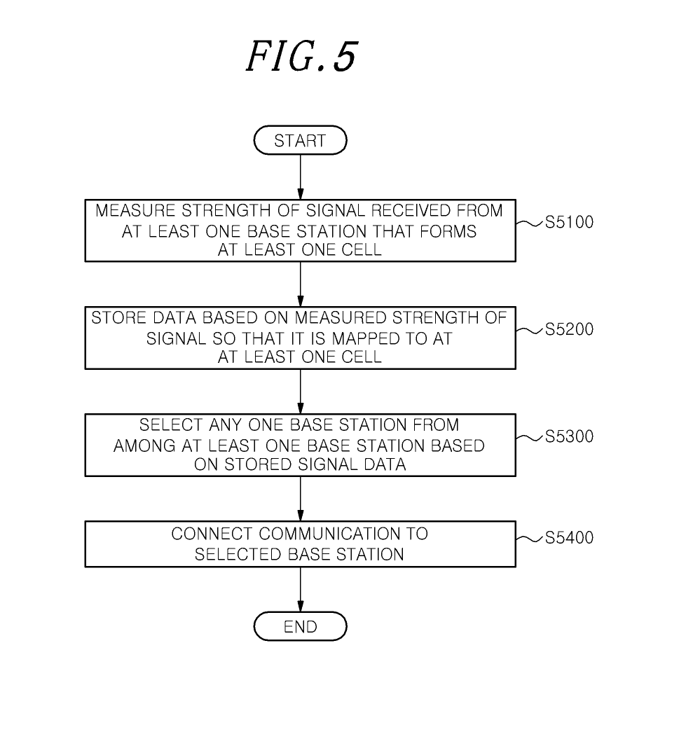

FIG. 5 is a flowchart illustrating a method of providing millimeter wave band-based communication connection service in accordance with an embodiment of the present invention.

Referring to FIG. 5, a mobile communication terminal measures the strength of a signal received from at least one base station that forms at least one cell at step S5100.

Thereafter, the mobile communication terminal stores signal data based on the measured strength of the signal so that it is mapped to at least one base station at step S5200.

In this case, the mobile communication terminal selects any one base station from among the at least one base station based on the stored signal data at step S5300.

Finally, the mobile communication terminal establishes communication with the selected base station at step S5400.

Since some descriptions of the method of providing millimeter wave band-based communication connection service, which is illustrated in FIG. 5, are the same as or can be easily derived from those of the methods of providing millimeter wave band-based communication connection service given in conjunction with FIGS. 1 to 4, they will be omitted.

The method of providing millimeter wave band-based communication connection service in accordance with an embodiment of the present invention, which is illustrated in FIG. 5, may be implemented as a computer-readable storage medium containing computer-executable instructions, such as an application or a program module that can be executed by a computer. The computer-readable medium may be any available medium that can be accessed by a computer, and includes volatile and nonvolatile media and detachable and non-detachable media. Furthermore, the computer-readable medium may include computer storage media, and communication media. The computer storage media include volatile and nonvolatile media and detachable and non-detachable media that are implemented using any method or technology for storing information, such as computer-executable instructions, data structures, program modules or other types of data. The communication media typically include computer-executable instructions, data structures, program modules, modulated data signals, such as carrier waves, other types of data, or other transmission mechanisms, and further includes any information transfer media.

The above-described method of providing millimeter wave band-based communication connection service in accordance with an embodiment of the present invention may be executed by an application (which may include a program that is included in a platform or an operating system (OS) basically installed on a terminal) that is basically installed in a terminal, or may be executed by an application (that is, a program) that is directly installed on a master terminal via an application server, such as an application store server or a web server related to the application or corresponding service, by a user. In this sense, the above-described method of providing millimeter wave band-based communication connection service in accordance with the embodiment of the present invention may be implemented by an application (that is, a program) basically installed on a terminal or directly installed by a user, and may be stored in a computer-readable storage medium.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A method of providing millimeter wave band-based communication connection service, the method being performed on a millimeter wave band-based mobile communication terminal, the method comprising:
measuring a strength of a signal received from at least one base station that forms at least one cell;
storing signal data based on the measured strength of the signal so that the signal data is mapped to the at least one base station;
selecting one base station from among the at least one base station based on the stored signal data; and
connecting communication to the selected base station.

2. The method of claim 1, wherein the signal data based on the measured strength of the signal is arranged in descending or ascending order, classified according to strength, and then stored.

3. The method of claim 1, further comprising setting communication with the at least one base station except for the selected base station to a standby state.

4. The method of claim 1, wherein selecting one base station from among the at least one base station based on the stored signal data is performed if a strength of a signal between the mobile communication terminal and a base station to which the mobile communication terminal has been connected is equal to or lower than a preset signal strength.

5. The method of claim 1, further comprising:
measuring strengths of signals received from a plurality of base stations, which form a plurality of cells, in real time or periodically based on a location of the mobile communication terminal;
compares signal data measured in real time or periodically with previously stored signal data; and
if the measured signal data is not identical to the previously stored signal data, updating the previously stored signal data with the measured signal data.

6. The method of claim 5, further comprising:
comparing a strength of a signal that is the strongest of the updated signal with a strength of a signal received from a base station to which the mobile communication terminal has been connected; and
if the strength of the signal that is the strongest of the updated signal is higher than the strength of the signal received from the base station to which the mobile communication terminal has been connected, establishing communication with a base station that transmits the strongest signal.

7. The method of claim 5, further comprising:
comparing a strength of a signal that is the strongest of the updated signal with a strength of a signal received from a base station to which the mobile communication terminal has been connected; and
if the strength of the signal that is the strongest of the updated signal is equal to or lower than the strength of the signal received from the base station to which the mobile communication terminal has been connected, maintaining a connection to the base station to which the mobile communication terminal has been connected.

8. The method of claim 1, further comprising:
measuring strengths of signals received from a plurality of base stations, which form a plurality of cells, in real time or periodically based on a location of the mobile communication terminal;
compares signal data measured in real time or periodically with previously stored signal data; and
if the measured signal data is identical to the previously stored signal data, maintaining the previously stored signal data.

9. The method of claim 8, further comprising:
maintaining a communication connection to the selected base station.

10. The method of claim 1, wherein:
the at least one base station transmits a signal for the communication connection service to the mobile communication terminal; and
the signal is a signal transmitted to the mobile communication terminal separately from a communication signal.

11. A millimeter wave band-based communication connection terminal, comprising:
a measurement unit configured to measure a strength of a signal received from at least one base station that forms at least one cell;
a storage unit configured to store signal data based on the measured strength of the signal so that the signal data is mapped to the at least one base station;
a selection unit configured to, if a strength of a signal between the mobile communication terminal and a base station to which the mobile communication terminal has been connected is equal to or lower than a preset signal strength, select one base station from among the at least one base station based on the stored signal data; and
a connection unit configured to connect communication to the selected base station.

12. The millimeter wave band-based communication connection terminal of claim 11, wherein the selection unit, if there is a base station to which the mobile communication terminal has been connected, selects one base station based on the stored signal data.
